(19) United States
(12) Patent Application Publication
(10) Pub. No.: US 2013/0139554 A1
(43) Pub. Date: Jun. 6, 2013

(54) METHOD FOR MANUFACTURING GLASS PREFORM

(71) Applicant: Tomohiro Ishihara, Yokohama-shi (JP)

(72) Inventor: Tomohiro Ishihara, Yokohama-shi (JP)

(73) Assignee: SUMITOMO ELECTRIC INDUSTRIES, LTD., Osaka-shi, Osaka (JP)

(21) Appl. No.: 13/816,948

(22) PCT Filed: Aug. 24, 2011
(86) PCT No.: PCT/JP2011/069026

§ 371 Date: Feb. 14, 2013

(30) Foreign Application Priority Data
Sep. 21, 2010 (JP) 2010-210762

(51) Int. Cl. C03C 25/22; C03C 25/42; C03C 25/10

(52) U.S. Cl. CPC C03C 25/223; C03C 25/107; C03C 25/42
USPC 65/416; 65/413; 65/421

(57) ABSTRACT

The present invention provides a method for producing a glass preform capable of improving the deposition efficiency of produced glass fine particles to a starting rod or a glass soot body. The method for manufacturing a glass preform includes controlling the temperature of SiCl₄ used as a source gas to 100° C. or more, producing glass fine particles having an average outer diameter of 90 nm or more in a flame of a burner for producing glass fine particles, and depositing the glass fine particles on a starting glass rod 13.

### TECHNICAL FIELD

The present invention relates to a method for manufacturing a glass preform, the method including producing a glass soot body by the vapor phase axial deposition method (VAD method), the outside vapor deposition method (OVD method), the multi-burner multi-layer deposition method (MMD method), or the like.

### BACKGROUND ART

Japanese Unexamined Patent Application Publication No. 11-180719 (Patent Literature 1) describes a method in which a porous soot body produced by a vapor-phase synthesis method is impregnated with a mixed solution containing additive fine particles dispersed therein and is then consolidated by heating to produce a glass preform. It is described in paragraph [0013] that particles which constitute a SiO₂-based porous body have a diameter of 500 to 1000 nm.

Japanese Unexamined Patent Application Publication No. 2004-300006 (Patent Literature 2) describes a manufacturing method in which previously prepared glass fine particles are introduced into a burner flame. This manufacturing method is different from a manufacturing method of the present invention in which glass fine particles are produced by supplying a gaseous source material, but in the method described in Patent Literature 2, the average particle diameter of the glass fine particles charged is 0.2 μm or less to suppress the occurrence of clogging due to aggregation of the glass fine particles in a source material supplying tube, thereby efficiently supplying the glass fine particles to a burner.

However, it is difficult for the methods for manufacturing a glass preform of Patent Literatures 1 and 2 to efficiently deposit the glass fine particles to a starting rod and a glass soot body.

### SUMMARY OF INVENTION

### Technical Problem

An object of the present invention is to provide a method for manufacturing a glass preform, which is capable of improving the deposition efficiency of glass fine particles to a starting rod and a glass soot body.

### Solution to Problem

In order to resolve the problem, the present invention provides a method for manufacturing a glass preform, the method including (1) controlling a temperature of a source gas to 100° C. or more, (2) charging the source gas into a burner for producing glass fine particles, the burner being disposed in a reaction container and the source gas having been controlled to 100° C. or more, (3) producing glass fine particles having an average outer diameter of 90 nm or more by flame hydrolysis reaction in a flame of the burner for producing glass fine particles, (4) depositing the produced glass fine particles on a starting rod disposed in the reaction container to form a glass soot body, and (5) heating the resultant glass soot body to a high temperature to form a transparent glass preform.

The average outer diameter of the glass fine particles is preferably 110 nm or more. In addition, examples of a method for forming the glass soot body include the VAD method, the OVD method, and the MMD method.

### Advantageous Effects of Invention

According to the present invention, the method for manufacturing a glass preform is capable of improving the deposition efficiency of glass fine particles to a starting rod and a glass soot body.

### BRIEF DESCRIPTION OF DRAWINGS

FIG. 1 is a conceptual view of a manufacturing equipment used in a method for manufacturing a glass preform according to an embodiment of the present invention.

FIG. 2 is a conceptual view illustrating behaviors of glass fine particles during deposition.

### DESCRIPTION OF EMBODIMENTS

An embodiment of the present invention is described below with reference to the drawings. The drawings are provided for explanation and not intended to limit the scope of the invention. In the drawings, the identical reference numeral denotes the same portion in order to avoid duplication of description. In the drawings, the dimensional ratios are not necessarily strict.

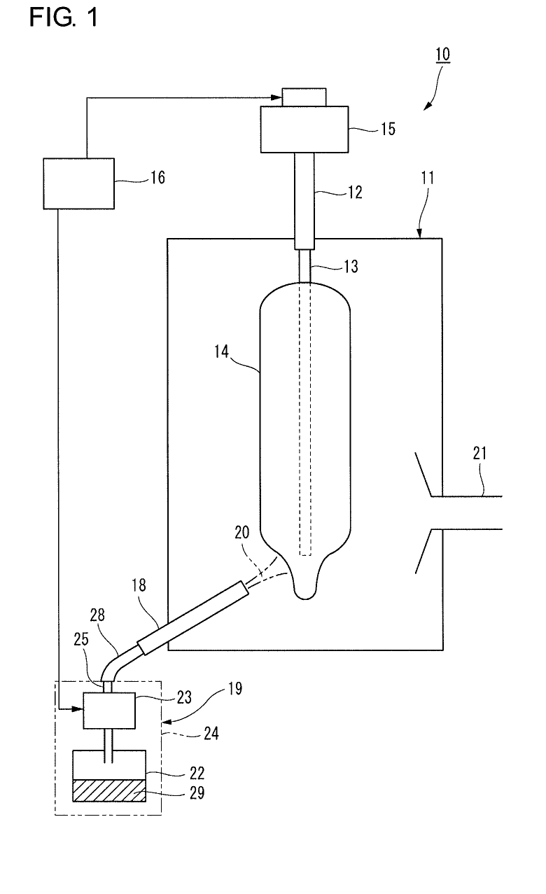

FIG. 1 is a conceptual view of a manufacturing equipment 10 used in a method for manufacturing a glass preform according to an embodiment of the present invention. The manufacturing equipment 10 performs deposition of glass fine particles by the VAD method and includes a supporting rod 12 suspended in a reaction container 11 from above, and a starting glass rod 13 provided on the lower side of the supporting rod 12. The glass fine particles are deposited on the starting glass rod 13 to form a glass soot body 14. The supporting rod 12 is gripped by a lifter 15 at the upper end thereof, and is lifted while being rotated by the lifter 15. The lifting speed of the lifter 15 is controlled by a controller 16 so that the outer diameter of the glass soot body 14 becomes uniform.

A burner 18 for cladding is provided at a lower position inside the reaction container 11, and a source gas is supplied to the burner 18 for cladding from a source gas supplying unit 19. The source gas supplying unit 19 includes a source material tank 22, a mass flow controller (MFC) 23, a temperature controlled booth 24, and a source gas supplying tube 25 so that a liquid source material 29 in the source material tank 22 is evaporated by controlling its temperature to be equal to or higher than the boiling point in the temperature controlled booth 24, and the amount of the source gas supplied to the burner 18 for cladding is controlled by the MFC 23. In addition, the temperature of the source gas supplying tube 25 up to the burner 18 for cladding is controlled by a heating element 28. In FIG. 1, a supplying unit for flame forming gases is not shown.

Further, SiCl₄ as the source gas, H₂ and O₂ as the flame forming gases, and N₂ as a burner seal gas are charged into the burner 18 for cladding. In addition, an exhaust tube 21 is provided on the side surface of the reaction container 11.

Next, procedures for producing the glass soot body 14 are described. First, the supporting rod 12 is attached to the lifter 15 and the starting glass rod 13 provided at the tip of the supporting rod 12 is placed in the reaction container 11. The glass fine particles are deposited on the starting glass rod 13 by the burner 18 for cladding while the starting glass rod 13 is rotated by the lifter 15. The glass soot body 14 formed by depositing the glass fine particles onto the starting glass rod 13 is pulled up by the lifter 15 according to the growth rate at the lower end of the glass soot body 14. Next, the resultant glass soot body 14 is heated to 1100° C. in a mixed atmosphere containing inert gas and chlorine and then heated to 1550° C. in a He atmosphere to form transparent glass.

In the method for manufacturing the glass preform according to the embodiment, the temperature of SiCl₄ used as the source gas to be charged in the burner for producing glass fine particles is controlled to 100° C. or more, and the glass fine particles deposited to the glass soot body 14 has an average outer diameter of 90 nm or more. With a SiCl₄ gas temperature of 100° C. or more, chemical reaction rapidly proceeds, increasing the amount of the glass fine particles produced and increasing the diameters of glass fine particles. In addition, as the particle diameter increases, aggregation (a plurality of glass fine particles are integrally combined to form particle groups) due to turbulent diffusion is accelerated, increasing the inertial mass of particle groups. The aggregation rate due to turbulent diffusion increases in proportion to the third power of the particle outer diameter.

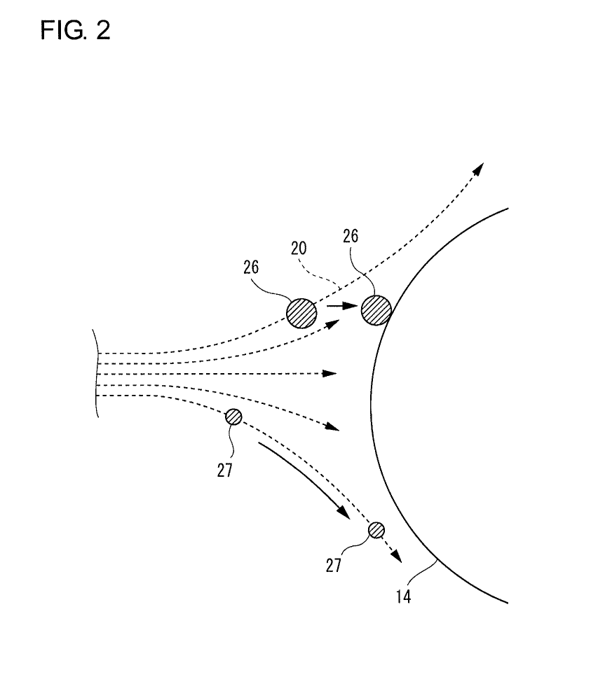

Here, behaviors of the glass fine particles in the gas flow in the flame are described in brief. FIG. 2 is a conceptual view illustrating behaviors of glass fine particles during deposition. A gas flow 20 in the flame formed by the burner 18 for cladding and containing SiCl₄ as the source gas etc. strikes on the glass soot body 14, and the direction thereof rapidly bends outward from the glass soot body 14.

When a gas flow in the flame is rapidly changed in direction, the force F_{θ} to direct a flow of glass fine particles along the gas flow in the flame increases as the inertial mass m increases, according to the formula, F₀=ma (N), where m (kg) is the inertial mass of glass fine particles and α (m/s²) is the acceleration of glass fine particles. The glass fine particles having large inertial mass m hardly follow a sharp bend. Therefore, it is understood that glass fine particles or particle groups having larger inertial mass m easily leave from the gas flow in the flame. In this case, each of F,F_{θ}, and a represents vector quantity.

In other words, comparing particles 26 having large inertial mass m1 with particles 27 having small inertial mass m2, the force F₁ required for directing the large particles 26 toward the direction (upward in FIG. 2) of the gas flow in the flame is larger than the force F₂ required for directing the small particles 27 toward the direction (downward in FIG. 2) of the gas flow in the flame (each of F₁ and F₂ is vector quantity). Therefore, the small particles 27 easily flow along the gas flow 20 in the flame, while the large particles 26 hardly flow along the gas flow 20 in the flame and thus move straight and are deposited to the glass soot body 14.

Consequently, in the case of large glass fine particles, the glass fine particles or particle groups easily leave from the gas flow in the flame in combination with the effect of increasing the inertial mass of particles groups due to accelerated aggregation. Thus, deposition of the glass fine particles onto the starting glass rod 13 or the glass soot body 14 used as a target is accelerated, and the deposition efficiency can be improved. According to the method for manufacturing a glass preform configured as described above, formation of glass fine particles in the flame and aggregation of the glass fine particles due to turbulent diffusion are accelerated, thereby improving source material yield.

### EXAMPLES

In examples and comparative examples, glass fine particles are deposited by the VAD method on a starting glass rod composed of silica glass and having a diameter of 25 mm and a length of 1000 mm, producing a glass preform. The gases charged in the burner for cladding include source gas (SiCl₄ at 1 to 7 SLM), flame forming gases (H₂ at 100 to 150 SLM and O₂ at 150 to 200 SLM), and burner seal gas (N₂ at 20 to 30 SLM). The resultant glass soot body is heated to 1100° C. in a mixed atmosphere containing inert gas and chlorine and then heated to 1550° C. in a He atmosphere, forming transparent glass.

The average outer diameter D (nm) of the glass fine particles is changed by changing the temperature T of source gas to be charged in the burner, and the deposition efficiency A (%) of the glass fine particles is evaluated. The average outer diameter D of the glass fine particles is measured by a BET surface area measuring method. The deposition efficiency A is defined as a ratio of the mass of glass fine particles actually deposited to the mass when SiCl₄ gas is 100% converted to SiO₂. The results are shown in a table.

TABLE

| | Temperature | Average outer | Deposition |
|---|---|---|---|
| | T (° C.) | diameter D | efficiency |
| | of source gas | (nm) of | A (%) of |
| | charged | glass fine | glass fine |
| | in burner | particles | particles |
| Example 1 | 110 | 90 | 35.1 |
| Example 2 | 110 | 100 | 37.2 |
| Example 3 | 130 | 110 | 39.2 |
| Example 4 | 200 | 130 | 43.0 |
| Comparative | 90 | 85 | 31.0 |
| Example 1 | | | |
| Comparative | 85 | 82 | 30.3 |
| Example 2 | | | |
| Comparative | 80 | 80 | 29.9 |
| Example 3 | | | |

The table reveals that in Examples 1 to 4 in which the temperature of the source gas charged into the burner is 100° C. or more, and the average outer diameter D of the glass fine particles is 90 nm or more, the deposition efficiency A of the glass fine particles is higher than that in Comparative Examples 1 to 3 in which the temperature of the source gas charged into the burner is lower than 100° C., and the average outer diameter D of the glass fine particles is smaller than 90 nm. In addition, it can be confirmed that the deposition efficiency A of the glass fine particles increases as the average outer diameter D of the glass fine particles increases, and the deposition efficiency A further increases at a source gas temperature of 130° C. or more and the average outer diameter D of the glass fine particles of 110 nm or more and reaches 43% in Example 4. In contrast, in Comparative Examples 1 to 3, it can be confirmed that the deposition efficiency A of the glass fine particles decreases as the source gas temperature decreases to be lower than 100° C. and the average outer diameter D of the glass fine particles decreases to be smaller than 90 nm, and the deposition efficiency A is only 29.9% in Comparative Example 3.

The method for manufacturing an optical fiber perform of the present invention is not limited to the above-described embodiment (the VAD method), and proper modifications and improvements can be arbitrarily made, and the OVD method and MMD method produce the same effect. In addition, although only SiCl₄ is used as the source gas in the examples, use of a mixed gas of SiCl₄ and GeCl₄ as the source gas produces the same effect. Further, the material, shape, dimensions, numerical values, form, number, location, etc. of each of the constituents elements of the above-described embodiment are optional within the scope of the present invention and are not limited.

### CITATION LIST

### Patent Literature

PTL 1: Japanese Unexamined Patent Application Publication No. 11-180719

PTL 2: Japanese Unexamined Patent Application Publication No. 2004-300006

1. A method for manufacturing a glass preform, the method comprising:
controlling a temperature of a source gas to 100° C. or more;
charging the source gas to a burner for producing glass fine particles, the burner being disposed in a reaction container and the source gas having been controlled to 100° C. or more;
producing glass fine particles having an average outer diameter of 90 nm or more by a flame hydrolysis reaction in a flame of the burner for producing glass fine particles;
depositing the produced glass fine particles on a starting rod disposed in the reaction container to form a glass soot body; and
heating the resultant glass soot body to a high temperature to form a transparent glass preform.

2. The method for manufacturing a glass preform according to claim 1, wherein the average outer diameter of the glass fine particles is 110 nm or more.

3. The method for manufacturing a glass preform according to claim 1,
wherein a method for forming the glass soot body is any one of a VAD method, an OVD method, and a MMD method.

4. The method for manufacturing a glass preform according to claim 2,
wherein a method for forming the glass soot body is any one of a VAD method, an OVD method, and a MMD method.
